(19) United States
(12) Patent Application Publication
(10) Pub. No.: US 2014/0238799 A1
(43) Pub. Date: Aug. 28, 2014

(54) Hand Truck/ Briefcase Mobile Table

(71) Applicant: Sandeep K. Sharma, Carteret, NJ (US)

(72) Inventor: Sandeep K. Sharma, Carteret, NJ (US)

(21) Appl. No.: 13/867,226

(22) Filed: Apr. 21, 2014

(51) Int. Cl. B62B 1/12; B62B 1/14; B62B 5/06; A45C 9/00

(52) U.S. Cl. CPC B62B 1/125; A45C 9/00; B62B 1/14; B62B 5/065
USPC 190/11; 108/11; 108/18

(57) ABSTRACT

A hand truck equipped with a tabletop for providing a work station and a bottom for carrying object(s). The bottom, which has wheels, is connected to a back, which has a handle. Objects are easier to move around because of the wheels and the basic lever system made of the back and bottom. The work station is attached to the back and can be used when the hand truck is upright. This hand truck is convenient because it can be used in environments that lack tables or shelves as a work station without requiring an extra piece of equipment.

### PRIORITY CLAIM

This application claims priority to U.S. Provisional Patent Application Ser. No. 61/808,618, filed Apr. 4, 2013. The above referenced application is incorporated herein by reference as if restated in full.

### BACKGROUND

There are many hand trucks sold in the market which facilitate the moving of objects through their use of wheels and a basic lever system. There are also portable work stations that enable an individual to do work such as writing in a ledger or using a laptop in an environment that lacks fixed tables or shelves. However, there are no portable work station and hand truck combinations that exist in the marketplace.

### SUMMARY

One aspect provides an apparatus comprising a back and a bottom. The back can be extended and retracted in order to match the height of the user, adjust the force necessary to move the load carried by the bottom, or make the apparatus more portable. In one aspect, the back comprises one or more legs. These legs are elongated beams that have substantially the same length as the back. In one aspect, the one or more legs comprise one or more telescopic sections. A leg may be entirely made up of telescopic sections, each of which is able to retract or extend into another, or only partially comprised of telescopic sections and partially of rigid sections. In another aspect, the back comprises one or more bridges for guiding and stabilizing the one or more legs. The bridges run substantially perpendicular to the legs.

In one aspect, the back comprises a handle. The handle enables a user to move the apparatus around. This movement encompasses pushing, pulling, picking up, or turning the apparatus. In one aspect, the handle is substantially perpendicular to the legs. In this aspect, the handle can either be a single bar that connects the one or more legs, or may itself comprise more than one prong. In one aspect, each prong is to be held by each hand. In another aspect, the handle comprises a button. The button enables a user to unlock the one or more telescopic sections with respect to each other, permitting the back as a whole to be either extended or retracted.

The bottom can used to carry a load. In one aspect, the bottom comprises a near end and a far end. The near end is or is closest to the part of the bottom that connects to the back. The far end is furthest from the part of the bottom that connects to the back. In another aspect, the bottom comprises one or more wheels. The wheels can be attached to the bottom at the near end, the far end, and/or any place in between. The wheels facilitate the forward, backward, and rotational movement of the apparatus. In still another aspect, one or more corners of the bottom are not attached to wheels. These corners without wheels increase the difficulty in moving the apparatus by providing more resistance through friction with the ground. By providing an apparatus with wheels in one or more corners, and without wheels in one or more corners, the user can facilitate the movement of the apparatus by lifting the apparatus at an angle, such that the wheels are in contact with the ground but the corners without wheels are lifted off the ground, and steady or immobilize the apparatus by lowering the corners without wheels so that they are in contact with the ground. In another aspect, these corners without wheels have pieces such as rough pads or friction pads, thereby increasing the friction between the corners and the ground.

In one aspect, the apparatus further comprises a tabletop for providing a work station. A user can place a laptop, a book, papers, or any other objects on the work station. In another aspect, the tabletop comprises a substantially flat surface. In still another aspect, the tabletop comprises one or more Velcro strips. If one or more relating partners to the one or more Velco strips are attached to a laptop, book, or any other object, then the interaction between the Velcro strips will substantially prevent the laptop, book, or any other object from sliding off the tabletop. In still another aspect, the tabletop comprises one or more non-slip pads. In still another aspect, the tabletop comprises one or more recesses for holding objects. These recesses may be of any shape or dimensions.

In one aspect, the apparatus further comprises a support assembly for adjustably connecting the tabletop to the apparatus. In another aspect, the support assembly comprises one or more hanging sections. In yet another aspect, the one or more hanging sections comprise one or more clamps for adjusting the length of the support assembly. In another aspect, the support assembly comprises one or more bearings that enable the tabletop to be rotated with respect to the back. These bearings can be hinges or any means to enable rotational motion between two objects.

In another aspect, the support assembly comprises one or more support sections. In yet another aspect, the one or more support sections comprise one or more foldable brackets for enabling the tabletop to be rotated with respect to the back.

In one aspect, the apparatus further comprises one or more cords. In another aspect, one end of each of the one or more cords is attached to the bottom of the apparatus, and the other end of each of the one or more cords is attached to the back of the apparatus. In still another aspect, the apparatus further comprises a clasp for adjusting and maintaining the configuration of the cords.

In one aspect, the bottom and the back are connected to each other by bearings, and the bottom and the back can be rotated with respect to each other so that the bottom can be placed flush against the back.

In one aspect, the back can be extended by pulling the handle away from the bottom. In another aspect, the back can be retracted by pushing the handle toward the bottom. In still another aspect, the back is locked in either a retracted position or extended position, and by pushing the button on the handle, the back can be unlocked. In this aspect, the back can then change from one position to another position.

In one aspect, the clamps of the vertical section of the support assembly can be loosened to enable a user to adjust the length of the support assembly, and then tightened to enable a user to lock the support assembly at a particular length. In this aspect, by changing the length of the support assembly, the tabletop will be raised or lowered.

In one aspect, an object, such as a briefcase, suitcase, shopping bag, etc., can be placed on the bottom. In another aspect, the object can be secured to the bottom by the one or more cords. In still another aspect, the clasp can be used to further secure the object by tightening the cords.

In one aspect, the apparatus further comprises a container, such as a briefcase, suitcase, etc. In one aspect, the bottom of the container is the bottom of the apparatus, such that the bottom of the container has wheels and a substantially rigid surface for conveying objects. In another aspect, the container sits on top of the bottom. In yet another aspect, the bottom fits substantially inside the container. In yet another aspect, the bottom fits wholly inside the container.

In one aspect, the tabletop can be rotated so that it is flush with the back and the back with or without the tabletop can be retracted fully or partially into the container through an opening. In another aspect, the back can be extended so that it sticks out of the container, and the tabletop can be rotated so that it is substantially perpendicular to the back. In another aspect, the container has knobs on the end opposite the wheels, allowing the bottom and the tabletop to be level with respect to the ground.

### BRIEF DESCRIPTION OF THE DRAWINGS

The feature and nature of the present disclosure will become more apparent from the detailed description set forth below when taken in conjunction with the accompanying drawings in which reference characters identify corresponding items.

FIG. 1 shows an aerial view of an exemplary apparatus;

FIG. 2 shows a side view of an exemplary apparatus;

FIG. 3 shows an alternate side view of an exemplary apparatus;

FIG. 4 shows an aerial view of an exemplary apparatus;

FIG. 5 shows a side view of an exemplary apparatus.

FIG. 6 shows an aerial view of an exemplary apparatus.

### DETAILED DESCRIPTION OF THE DRAWINGS

The disclosed methods and devices below may be described both generally as well as specifically. It should be noted that when the description is specific to an aspect, that aspect should in no way limit the scope of the methods and devices.

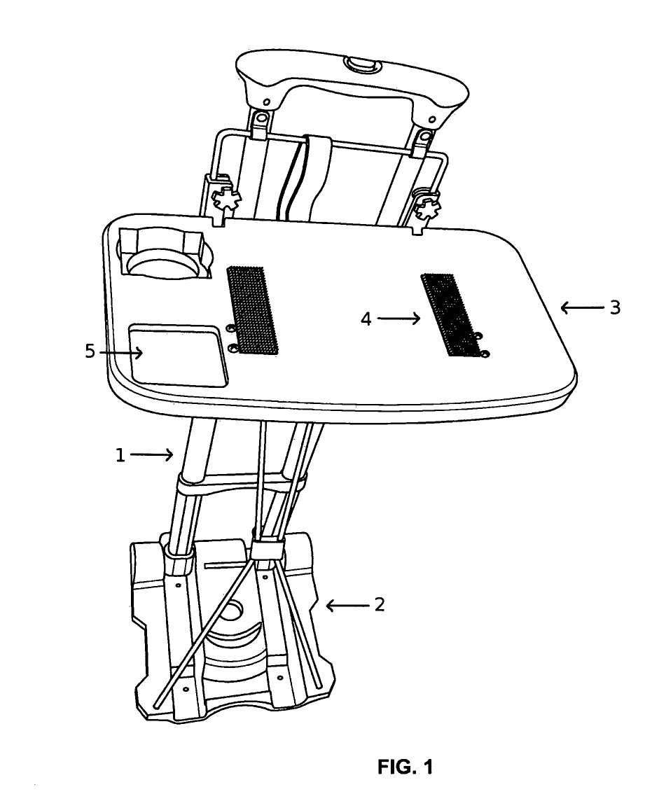

FIG. 1 is an aerial view of an exemplary apparatus. The apparatus comprises a back 1 and a bottom 2. The back 1 may comprise a tabletop 3. The table top 10 may comprise one or more Velcro strips 4 and one or more recesses 5.

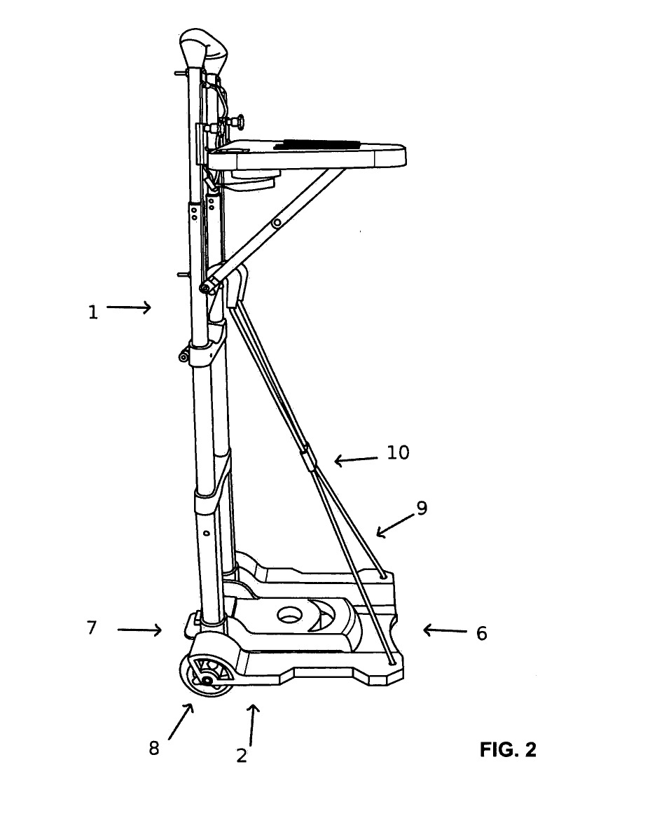

FIG. 2 is a side view of an exemplary apparatus. The bottom 2 comprises a far end 6 and a near end 7. The near end 7 may comprise wheels 8.

The bottom 2 may further comprise one or more cords 9 which enable an object to be secured to the bottom 2. One end of the one or more cords 9 may be attached to the far end 6, and the other end of the one or more cords 9 may be attached to the back 1. The one or more cords 9 may comprise a clasp 10 for tightening the one or more cords 9 to better secure an object placed on the bottom 2.

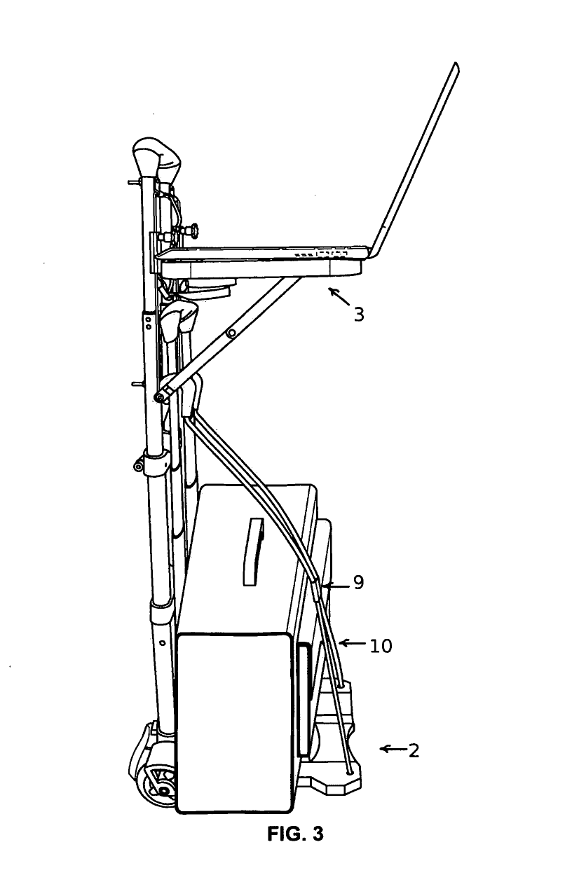

FIG. 3 is an alternate side view of an exemplary apparatus. A piece of luggage is placed upon the bottom 2 and secured by one or more cords 9 and a clasp 10. A laptop is placed upon the tabletop 3.

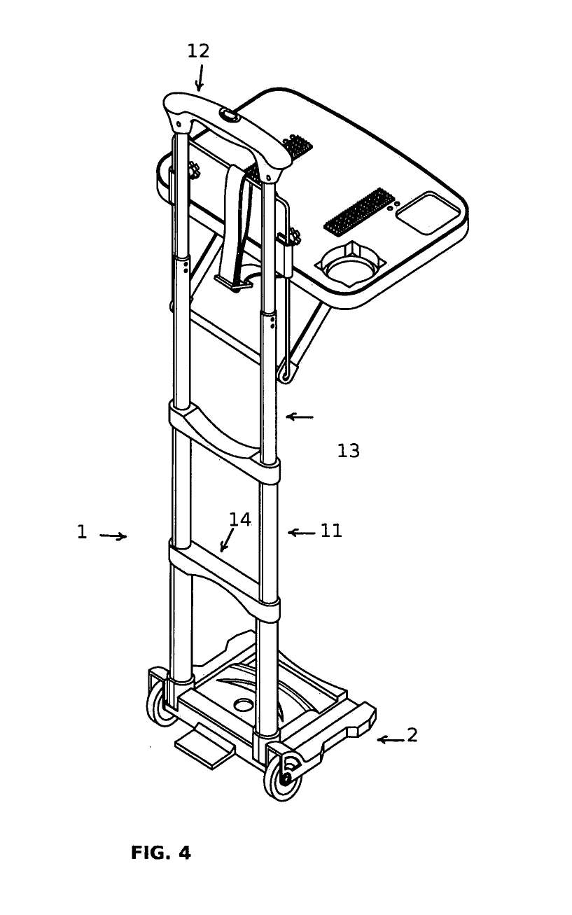

FIG. 4 is an aerial view of an exemplary apparatus. The back 1 may comprise one or more legs 11, and a handle 12. The one or more legs 11 may comprise one or more telescopic sections 13. The telescopic sections 13 may be constructed so that one or more telescopic sections 13 closer to the handle 12 may move into one or more telescopic sections 13 closer to the bottom 2. The back 1 may further comprise one or more bridges 14 which connect one or more legs 11.

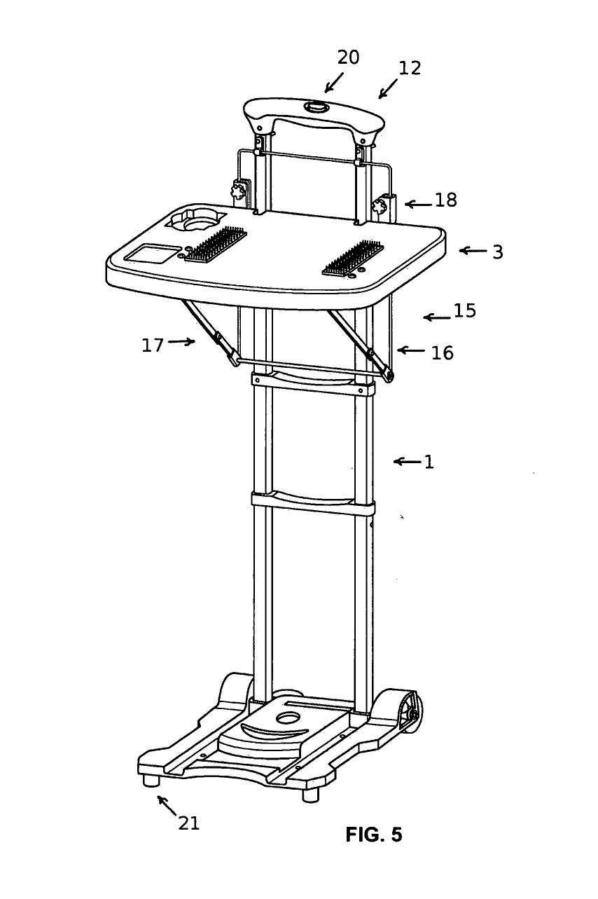

FIG. 5 shows a side view of an exemplary apparatus. The back 1 may comprise a support assembly 15 for connecting the back 1 to the tabletop 3.

The support assembly 15 may comprise one or more hanging sections 16 and one or more support sections 17. The hanging sections may comprise clamps 18 for raising and lowering the support assembly 15, thereby raising and lowering the tabletop 3. The one or more support sections 17 enable the tabletop 3 to rotate so that it is flush with the back 1.

The handle 12 may comprise a button 20, for enabling the unlocking of the one or more telescopic sections 13 with respect to one another, so that the back 1 can retract or extend.

The far end 6 of the bottom 2 may comprise one or more pieces 21 that increase the friction between the bottom 2 and the ground.

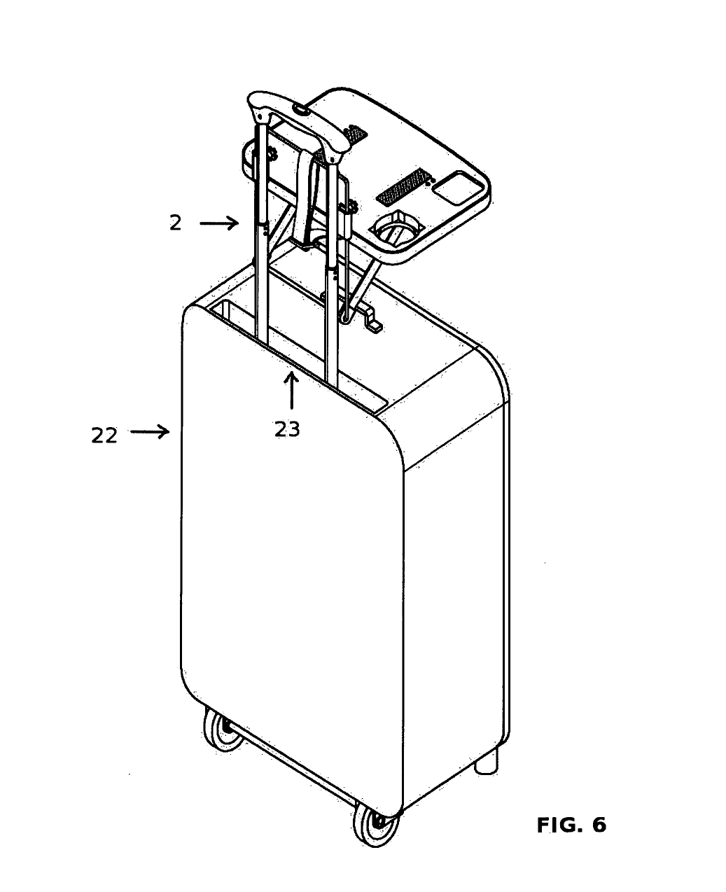

FIG. 6 shows an aerial view of an exemplary apparatus. The back 1 extends out of a container 22 through the opening 23.

What is claimed as new and desired to be protected by Letters Patent of the United States is:

1. An apparatus comprising:
a tabletop, a back, a bottom, and one or more wheels.

2. The apparatus in claim 1, wherein one or more bearings connect the back to the bottom and enable rotational motion between the tabletop and the back.

3. The apparatus in claim 1, wherein the back comprises one or more legs, each of the one or more legs comprising one or more telescopic sections.

4. The apparatus in claim 3, wherein the back comprises a handle, and the handle comprises a button for unlocking the telescopic sections with respect to each other.

5. The apparatus in claim 3, wherein the back comprises two or more legs and one or more bridges for stabilizing the two or more legs.

6. The apparatus in claim 1, further comprising one or more cords for securing an object to the bottom.

7. The apparatus in claim 6, further comprising a clasp for adjusting and maintaining the configuration of the cords.

8. The apparatus in claim 1, wherein one or more bearings connect the tabletop to the back and enable rotational motion between the tabletop and the back.

9. The apparatus in claim 1, further comprising a support assembly for adjusting the height of the tabletop with respect to the back.

10. The apparatus in claim 1, further comprising a container, the container comprising an opening through which the back can be extended or retracted.

11. An apparatus comprising:
a tabletop;
a back, the back comprising one or more legs, each of the one or more legs divided into one or more telescopic sections, and a handle, the handle comprising a button for unlocking the one or more telescopic sections with respect to each other;
a bottom, the bottom comprising one or more wheels;
one or more bearings connecting the back to the bottom and enabling rotational motion between the back and bottom;
one or more bearings connecting the tabletop to the back and enabling rotational motion between the tabletop and the back;
a support assembly for adjusting the height of the tabletop with respect to the back and enabling rotational motion between the tabletop and the back;

12. The apparatus in claim 11, wherein the support assembly comprises one or more hanging sections, one or more support sections, and one or more clamps; the one or more support sections connect the tabletop to the hanging sections, the hanging sections are connected to the back by clamps, and the clamps allow the hanging sections to be raised or lowered.

13. A method of using an apparatus comprising:
providing an apparatus comprising a back, a bottom, and a tabletop, the bottom comprising wheels, and the tabletop attached to the back;
adding or removing an object to the bottom;
moving the apparatus by pushing or pulling the back;
stationing the apparatus by positioning the bottom on the ground;
using the tabletop as a work station.

14. The method in claim 13, wherein the back comprises one or more legs, each of the one or more legs divided into one or more telescopic sections.

15. The method in claim 14, wherein:
the back further comprises a button;
the one or more telescopic sections are originally in a locked position with respect to each other, and by pressing the button, the telescopic sections can be extended fully; and
the telescopic sections lock into position with respect to each other when extended sufficiently.

16. The method in claim 13, further comprising:
providing a support assembly for adjusting the height of the tabletop with respect to the back; and adjusting the height of the tabletop with respect to the back.

17. The method in claim 13, further comprising:
providing one or more bearings for connecting the back to the bottom and enabling rotational motion between the tabletop and the back; and
rotating the tabletop with respect to the back.

18. The method of claim 13, further comprising:
providing one or more cords; and
securing an object to the bottom by tightening the cords against the object.

19. The method in claim 13, further comprising:
providing a container for housing the apparatus, the container comprising an opening through which the back can be extended or retracted;
providing one or more bearings for connecting the back to the bottom and enabling rotational motion between the tabletop and the back;
rotating the tabletop with respect to the back so that the tabletop is substantially flush against the back and retracting the back into the container; and
extending the back so that it extends out of the container and rotating the tabletop with respect to the back so that the tabletop is substantially perpendicular against the back;

20. The apparatus in claim 1, further comprising:
one or more bearings connecting the tabletop to the back and enabling rotational motion between the tabletop and the back; and
a container, the container comprising an opening through which the back can be extended or retracted.
